(19) United States
(12) Patent Application Publication
(10) Pub. No.: US 2024/0219928 A1
(43) Pub. Date: Jul. 4, 2024

(54) AIRCRAFT AND CONTROL METHOD THEREFOR, AND SYSTEM AND STORAGE MEDIUM

(71) Applicant: SZ DJI TECHNOLOGY CO., LTD., Shenzhen (CN)

(72) Inventors: Liyao ZHAO, Shenzhen (CN); Yuhao WU, Shenzhen (CN)

(73) Assignee: SZ DJI TECHNOLOGY CO., LTD., Shenzhen (CN)

(21) Appl. No.: 18/604,460

(22) Filed: Mar. 13, 2024

Related U.S. Application Data
(63) Continuation of application No. PCT/CN2021/118540, filed on Sep. 15, 2021.

(51) Int. Cl. G05D 1/654; B64U 20/87; G05D 1/224; G05D 1/672; G06T 7/73; B64U 101/30; G05D 109/20

(52) U.S. Cl. CPC G05D 1/6545; B64U 20/87; G05D 1/2247; G05D 1/672; G06T 7/74; B64U 2101/30; B64U 2201/20; G05D 2109/20; G06T 2207/10032

(57) ABSTRACT

An unmanned aerial vehicle (UAV) control method includes: obtaining a distance between the UAV and a home point; obtain, based on the distance, a first image captured by photographing a home point with a first photographing device; sending the first image to a terminal device for display; and upon receiving a first control instruction sent by the terminal device, adjusting an attitude of the UAV based on the first control instruction. The present disclosure can improve the safety of the UAV during returning and landing. A UAV, a system and a storage medium are also provided.

### RELATED APPLICATIONS

This application is a continuation application of PCT application No. PCT/CN2021/118540, filed on Sep. 15, 2021, and the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the technical field of unmanned aerial vehicles, and in particular to an unmanned aerial vehicle (UAV), a control method and system thereof, and a storage medium.

### BACKGROUND

When a UAV lands, sometimes the user cannot observe the situation below the UAV during the landing, and thus cannot adjust the position of the UAV properly to select a suitable landing location. This situation is particularly serious when the UAV is flying beyond the visual range or when the sight of the user is blocked, which is detrimental to the safety of the UAV or the safety of people and objects in the landing area.

### SUMMARY

The present disclosure provides a UAV, a control method and system thereof, and a storage medium, with the object of improving the safety of the UAV when returning to home and landing.

In one aspect, the present disclosure provides an aircraft, including: a first photographing device; at least one storage medium storing at least one set of instructions for controlling the aircraft; and at least one processor in communication with the at least one storage medium, where during operation, the at least one processor executes the at least one set of instructions to cause the aircraft to at least: during a period of the aircraft returning from a first position to landing on a home point, obtain a first image captured by the first photographing device in a direction toward the home point, and send the first image to a terminal device for display.

In another aspect, the present disclosure provides a control method for an aircraft, including: during a period of the aircraft returning from a first position to landing on a home point, obtaining a first image captured by a first photographing device in a direction toward the home point; and sending the first image to a terminal device for display.

In yet another aspect, the present disclosure provides an aircraft system, including: an aircraft; and a terminal device in communication with the aircraft and having a display device configured to display images, where the aircraft includes: a first photographing device, at least one storage medium storing at least one set of instructions for controlling the aircraft, and at least one processor in communication with the at least one storage medium, where during operation, the at least one processor executes the at least one set of instructions to cause the aircraft to at least: during a period of the aircraft returning from a first position to landing on a home point, obtain a first image captured by the first photographing device in a direction toward the home point, and send the first image to the terminal device for display.

Some exemplary embodiments of the present disclosure provide a UAV, a control method and system thereof, and a storage medium. A first image is obtained by using a first photographing device to photograph a home point based on a distance between a UAV and the home point, the first image is then sent to a terminal device for display. Thus, it would be convenient for a user to understand environmental conditions in an area near the home point; and the user can operate the terminal device according to the environmental conditions to make the terminal device send a first control instruction to the UAV. The UAV can adjust an attitude thereof based on the first control instruction, such as avoiding obstacles near the home point, so as to improve the safety of the UAV when it returns and lands.

It should be understood that the above general description and the following detailed description are only exemplary and explanatory, and do not limit the present disclosure.

### BRIEF DESCRIPTION OF THE DRAWINGS

In order to clearly illustrate the technical solutions of the embodiments of the present disclosure, the following will briefly introduce the drawings for the description of some exemplary embodiments. Apparently, the accompanying drawings in the following description are some exemplary embodiments of the present disclosure. For a person of ordinary skill in the art, other drawings may also be obtained based on these drawings without creative efforts.

FIG. 1 is a schematic flowchart of a control method for a UAV according to some exemplary embodiments of the present disclosure;

FIG. 2 is a schematic diagram of data transmission between a terminal device and a UAV;

FIG. 3 is a schematic diagram of a first photographing device photographing a home point according to some exemplary embodiments of the present disclosure;

FIG. 4 is a schematic diagram of a UAV equipped with a first photographing device according to some exemplary embodiments of the present disclosure;

FIG. 5 is a schematic diagram of a terminal device displaying a first image according to some exemplary embodiments of the present disclosure;

FIG. 6 is a schematic diagram of a terminal device displaying a first image and a second image according to some exemplary embodiments of the present disclosure;

FIG. 7 is a schematic block diagram of a UAV according to some exemplary embodiments of the present disclosure; and

FIG. 8 is a schematic block diagram of a UAV system according to some exemplary embodiments of the present disclosure.

### DETAILED DESCRIPTION

The technical solutions in some exemplary embodiments of the present disclosure will be described below with reference to the accompanying drawings in the embodiments of the present disclosure. Obviously, the described embodiments are part of the embodiments of the present disclosure, but not all of the embodiments. Based on the exemplary embodiments in the present disclosure, all other embodiments obtained by a person of ordinary skill in the art without creative efforts fall within the scope of protection of the present disclosure.

The flowcharts shown in the accompanying drawings are only examples and do not necessarily include all contents and operations/steps, nor are they necessarily performed in the order described. For example, some operations/steps may also be separated, combined or partially combined. Therefore, the actual execution order may be altered based on actual conditions.

Some exemplary embodiments of the present disclosure will be described in detail below with reference to the accompanying drawings. The following exemplary embodiments and features thereof may be combined with each other without conflict.

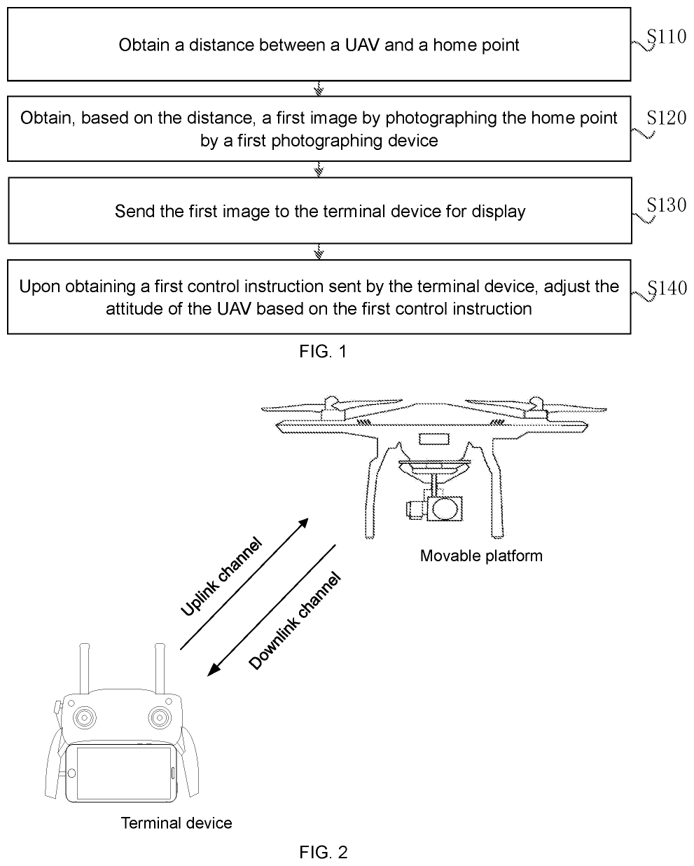

With reference to FIG. 1, FIG. 1 is a schematic flowchart of a control method for a UAV according to some exemplary embodiments of the present disclosure; the UAV control method can be applied in a UAV or a UAV control device to control the return and landing of the UAV; for example, the UAV may be a rotor-type UAV, such as a four-rotor UAV, a six-rotor UAV, an eight-rotor UAV, etc. (it is noted that UAV herein is merely an example for easy description, the present disclosure also covers other types of aircrafts).

Specifically, as shown in FIG. 2, the UAV can communicate with a terminal device. For example, data may be transmitted between the terminal device and the UAV via a wireless channel.

Exemplarily, the terminal device may include at least one of a mobile phone, a tablet computer, a notebook computer, a desktop computer, a personal digital assistant, a wearable device (such as head-mounted glasses), a remote control, etc.

Exemplarily, as shown in FIG. 2, the wireless channel from the UAV to the terminal device may be referred to as a downlink channel, which is used to transmit data collected by the UAV. For example, videos, pictures, sensor data, and UAV telemetry data such as UAV status information (also referred to as OSD).

Exemplarily, the wireless channel from the UAV to the terminal device includes an image transmission link; usually a UAV and a terminal device each include an antenna and a signal processing chip to complete sending and receiving signals.

Exemplarily, as shown in FIG. 2, the wireless channel from the terminal device to the UAV is referred to as an uplink channel, which is used to transmit remote control data. For example, when the UAV is an aircraft, the uplink channel can be used to transmit flight control instructions and control instructions such as photographing, video recording, returning, etc.

As shown in FIG. 1, the UAV control method according to some exemplary embodiments of the present disclosure may include steps S110 to S140.

S110. Obtain a distance between a UAV and a home point.

The home point is a location or area where the UAV will land. For example, the home point can be determined based on the take-off location, or can be specified by a user, or can be a location determined during autonomous return, such as low-battery return, and is of course not limited to the foregoing.

In some exemplary embodiments, a location of the UAV and a location of the home point can be obtained. The distance between the UAV and the home point may be determined based on the location of the UAV and the location of the home point.

In some exemplary embodiments, the distance between the UAV and the home point can be determined based on the current status of the UAV, such as the remaining power thereof. For example, when the remaining power of the UAV can be used by the UAV to fly a first distance, a second distance that is less than or equal to the first distance may be determined to be the distance between the UAV and home point. It can also be determined that the second distance in the flight direction is the home point.

For example, the distance between the UAV and the home point, as well as the location of the home point can be determined based on a return instruction. The return instruction can be, for example, used to instruct the UAV to land after flying a corresponding distance. The return instruction can be sent by the terminal device in response to a user's operation, and is of course not limited to the foregoing.

S120. Obtain, based on the distance, a first image by photographing the home point by a first photographing device.

The first photographing device may be fixedly connected to the UAV, detachably connected thereto, or provided in an integrated manner.

The first photographing device may be connected below the UAV or in front of the UAV, and is of course not limited to the foregoing.

In some exemplary embodiments, when it is determined that the UAV is above the home point based on the distance, the first photographing device can photograph directly below therebelow to obtain the first image.

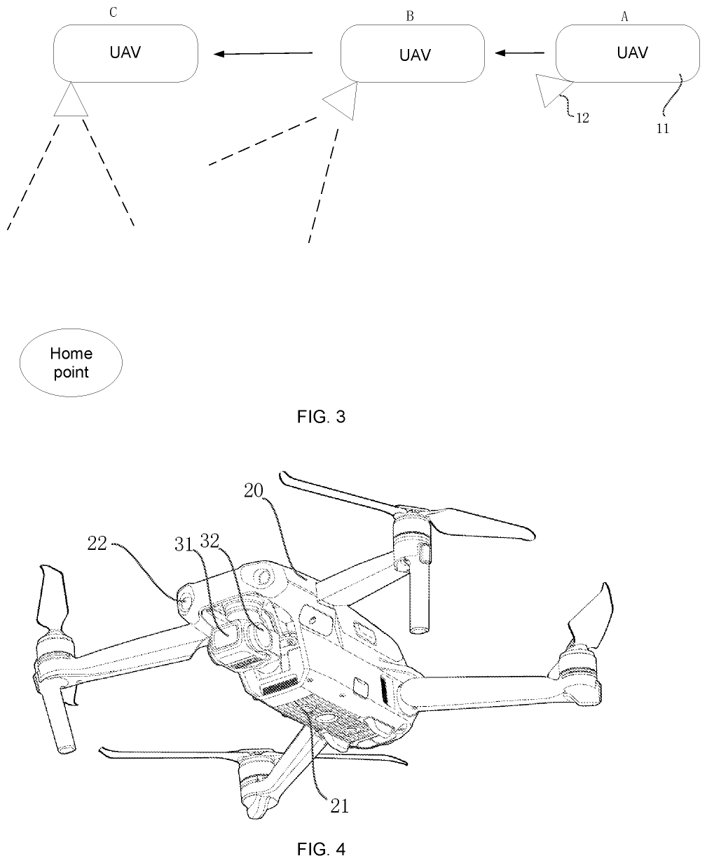

With reference to FIG. 3, following the UAV 11 flies from a position A to a position C, it is above the home point and obtains the first image captured directly below by the first photographing device 12.

In some exemplary embodiments, the obtaining, based on the distance, the first image by photographing the home point by the first photographing device may include: when the distance is less than or equal to a preset first distance threshold, obtaining the first image by photographing the home point by the first photographing device.

For example, the first distance threshold may range from 10 meters to 50 meters, such as 20 meters.

With reference to FIG. 3, when UAV 11 flies to a position B, the distance thereof from the home point is equal to the preset first distance threshold. When continuing to fly from the position B to the position C, the distance to the home point is less than the preset first distance threshold. During this period, the first image can be obtained by the first photographing device 12 photographing the home point.

The first image obtained by photographing the home point can be used to indicate the environmental conditions of the area where the home point is located, such as whether there are obstacles, water, etc. The first image can therefore serve as a reference for controlling the UAV.

In some exemplary embodiments, the obtaining of the first image by photographing the home point by the first photographing device may include: adjusting an attitude of the first photographing device so that a photographing direction of the first photographing device faces the home point; and obtaining the first image captured by the first photographing device.

Exemplarily, the adjusting of the attitude of the first photographing device may include: adjusting an attitude of the UAV and/or an attitude of a gimbal, where the gimbal mechanically couples the first photographing device to the UAV.

Exemplarily, with reference to FIG. 4, the first photographing device 21 maybe directly connected to the UAV 20, and the attitude of the first photographing device 21 can be adjusted by adjusting the attitude of the UAV 20, so as to adjust the photographing direction of the first photographing device 21. For example, the first photographing device 21 mayinclude a vision camera underneath the UAV 20.

Exemplarily, with reference to FIG. 4, the first photographing device 31 is mechanically coupled to the UAV 20 via the gimbal 32. For example, the first photographing device 31 maybe mounted on the gimbal 32, and the gimbal 32 maybe mounted on the UAV 20. The first photographing device 31 maybe fixedly connected to the gimbal 32, or can be detachably connected thereto. The attitude of the first photographing device 31 can be adjusted by adjusting the attitude of the gimbal 32, so as to adjust the photographing direction of the first photographing device 31. For example, the attitude of the gimbal 32 maybe adjusted based on the attitude of the UAV 20 and a target attitude of the first photographing device 31. For example, the gimbal 32 mayinclude a single-axis gimbal, a two-axis gimbal, or a three-axis gimbal; it can adjust the attitude in at least one of the following directions: a pitch direction, a roll direction, or a yaw direction.

Exemplarily, the adjusting of the attitude of the first photographing device may include: adjusting the attitude of the first photographing device based on a vertical height and a horizontal distance between the UAV and the home point. For example, the orientation of the home point relative to the UAV may be determined based on the vertical height and the horizontal distance; the attitude of the first photographing device may be adjusted based on the orientation of the home point relative to the UAV, so that the shooting direction of the first photographing device is made face the home point.

Exemplarily, a target pitch attitude of the first photographing device may be determined based on the vertical height and horizontal distance between the UAV and the home point; the attitude of the first photographing device may be adjusted based on the target pitch attitude. For example, an angle between a connection line between the home point and the UAV and a horizontal plane may be determined based on the vertical height and the horizontal distance, and then the target pitch attitude of the first photographing device may be determined based on the angle, such as the target pitch angle. By adjusting the attitude of the UAV and/or the attitude of the gimbal, the pitch angle of the first photographing device is made to be approximately equal to the target pitch angle, so that the photographing direction of the first photographing device is made face the home point.

In some exemplary embodiments, the obtaining of the first image by photographing the home point with the first photographing device based on the distance may include: when the distance is less than or equal to a preset second distance threshold, obtaining the first image directly below the UAV.

Exemplarily, the second distance threshold can be determined based on a field angle of the first photographing device. For example, the second distance threshold may be positively related to the field angle. The larger the field angle is, the larger the second distance threshold is. When the distance between the UAV and the home point is less than or equal to the second distance threshold, the photographing direction of the first photographing device is roughly directly therebelow, and the first image taken at this time includes the image of the home point.

Exemplarily, the second distance threshold is smaller than the first distance threshold. For example, when the distance between the UAV and the home point is less than the first distance threshold but greater than the second distance threshold, the pitch angle of the first photographing device below the horizontal plane is 0 to 90 degrees, optionally 45 to 90 degrees. When the distance between the UAV and the home point is less than the second distance threshold, the pitch angle of the first photographing device below the horizontal plane is approximately 90 degrees.

Exemplarily, when the UAV flies toward the home point, such as when the distance to the home point is less than or equal to the first distance threshold, the attitude of the first photographing device may be adjusted smoothly in order to prevent sudden changes in the first image. This helps the user understand the environment near the home point based on the first image.

S130. Send the first image to a terminal device for display.

Exemplarily, with reference to FIG. 5, the first image can be displayed on a display device of the terminal device, and the user can understand the environmental conditions of the area where the home point is located based on the first image displayed, for example, determining whether there are obstacles, waters, etc., so as to provide a reference for controlling the UAV.

Exemplarily, the terminal device may adjust the display area and size of the first image according to the user's zoom operation, or may adjust the area where the first image is displayed on the display device according to the user's drag operation.

Exemplarily, the terminal device can identify preset targets in the first image based on a machine learning model, such as high buildings, trees, water bodies and other targets that may affect landing safety. When the preset target(s) is recognized, the terminal device may output corresponding prompt information, such as marking the preset target(s) on the displayed first image, but is of course not limited to the foregoing. By outputting prompt information, it may facilitate the user controlling the UAV.

S140. Upon obtaining a first control instruction sent by the terminal device, adjust the attitude of the UAV based on the first control instruction.

During a process of the UAV flying toward the home point, the user can understand/know the environment near the home point based on the first image, and operate the terminal device (such as operating a joystick of the remote control) based on the environment. The operating device can send the first control instruction to the UAV, such as at least one of a speed adjustment instruction, an attitude adjustment instruction, or a height adjustment instruction. The speed adjustment instruction is used to adjust the horizontal position of the UAV; the attitude adjustment instruction is used to adjust the attitude of the UAV; the height adjustment instruction is used to instruct the UAV to ascend or descend. The adjustment of the attitude of the UAV based on the first image, for example, controlling the horizontal movement of the UAV, can avoid obstacles when landing at the home point, or adjust the landing position in time to improve landing safety.

Exemplarily, when the user determines that landing at the home point is not dangerous based on the first image, the user does not need to operate the terminal device, and the UAV can land at the home point autonomously. Of course, it is not limited to the foregoing, for example, the user can also operate the terminal device to control the landing of the UAV, such as controlling the speed during landing.

In some exemplary embodiments, the obtaining of the first image by photographing the home point with the first photographing device based on the distance may include: when the UAV is not performing a photographing task, obtaining the first image by photographing the home point with the first photographing device.

Exemplarily, the UAV may perform shooting tasks while flying, such as following a photographing target for photographing, circling a photographing target for photographing, flying and photographing according to a preset trajectory, etc., of course, it is not limited to the foregoing. When the UAV performs a photographing task, the first photographing device may not photograph the home point.

Exemplarily, the UAV may prioritize performing the photographing task. Of course, it is not limited to the foregoing. For example, when the UAV returns home with low power, the photographing task may be canceled. In addition, based on the distance between the UAV and the home point, it may obtain the first image by photographing the home point with the first photographing device, and then send the first image to the terminal device for display.

In some exemplary embodiments, the method may further include: upon receiving a second control instruction sent by the terminal device, adjusting the attitude of the first photographing device based on the second control instruction.

Exemplarily, when obtaining the first image by photographing the home point with the first photographing device, the attitude of the first photographing device may also be adjusted in response to the user's control operation to capture a target of interest to the user. For example, when it is determined based on the first image that there is no danger in landing at the home point, the user may adjust the attitude of the first photographing device via a control operation to obtain an image of a target of interest.

In some exemplary embodiments, the obtaining of the first image by photographing the home point with the first photographing device may include: obtaining the first image photographed by a first vision camera, where the first vision camera is mounted below the UAV.

Exemplarily, when the UAV is not equipped with a first photographing device specifically used for capturing images, a first vision camera used for environmental perception may be used as the first photographing device.

Exemplarily, with reference to FIG. 4, a vision camera 21 is mounted below the UAV 20, and the vision camera is a vision sensor of UAV, which mainly includes a vision camera sensor and a vision camera lens. It is usually used for environmental perception so that the UAV's control system can control the UAV to make a series of actions based on the environment, such as braking to avoid obstacles.

In some exemplary embodiments, the functionality of a vision camera generally does not require it to output color images, so its images may be black and white. By obtaining the first image of the home point captured by the first vision camera 21, and sending the first image to the terminal device for display, it can facilitate users to understand the environmental conditions of the area where the home point is located.

Exemplarily, the obtaining of the first image photographed by the first vision camera may include: obtaining the first image photographed by a monocular vision camera in a downward-looking binocular vision camera. The downward-looking binocular vision camera can determine the three-dimensional position of an object(s) in the field of view based on the images taken by two vision cameras, so that the UAV can determine its own position. The image captured by the monocular vision camera in the downward-looking binocular vision camera can facilitate the user to understand the environmental conditions of the area where the home point is located, and can also reduce the amount of data transmission.

Exemplarily, the first vision camera may include a fisheye lens and/or a wide-angle lens, which has a larger observation range. When the distance between the UAV and home point is less than or equal to the first distance threshold, even without adjusting the attitude via the gimbal, the image captured by the first vision camera may still include the home point, which is convenient for users to understand the environmental conditions of the area where the home point is located.

Exemplarily, the obtaining of the first image photographed by the first vision camera may include: performing preset processing on the first image photographed by the first vision camera, where the preset processing at least includes de-distortion processing.

Exemplarily, the de-distorted image can better reflect the shape and positional relationship of objects in the field of view, making it easier for users to accurately understand the environmental conditions of the area where the home point is located.

In some exemplary embodiments, the method may further include: obtaining a second image photographed by a second photographing device located on a peripheral side of the UAV, where peripheral side includes at least one of a front side, a rear side, a left side, or a right side; and then sending the second image to the terminal device for display.

Exemplarily, a second photographing device on the front side captures a second image directly in front of the UAV, a second photographing device on the rear side captures a second image directly behind the UAV, a second photographing device on the left captures a second image on the left side of the UAV, and a second photographing device on the right captures a second image on the right side of the UAV. For example, as shown in FIG. 4, a second photographing device 22 is provided at the front end of the UAV 20, and the second photographing device 22 is used to photograph images directly ahead.

Exemplarily, when the distance between the UAV and home point is less than or equal to the preset first distance threshold, obtain the first image by photographing the home point with the first photographing device, and obtain the second image captured by the second photographing device located on the peripheral side of the UAV. The first image and the second image are then sent to the terminal device for display. The second image can indicate the environmental conditions around the UAV to facilitate the user to control the UAV to land safely. For example, when the second image indicates that there is a building in front of the UAV, the user may control the UAV to land in advance, or avoid the building to prevent collision with the building during flight to the home point.

Exemplarily, the second photographing device may include at least one of the following: a first person view (FPV) camera, a forward vision camera, a rear vision camera, a left vision camera, or a right vision camera. For example, a first person view camera can be fixedly connected to the head of the UAV for capturing images of the front side.

Exemplarily, the first person view camera can also be connected to the head of the UAV via a gimbal, such as a gimbal capable of adjusting the pitch angle. The first person view camera may serve as the first photographing device. By adjusting the attitude of the gimbal, the attitude of the first person view camera can be adjusted so that the photographing direction of the first person view camera can face the home point; and then a first image can be obtained by the first person view camera.

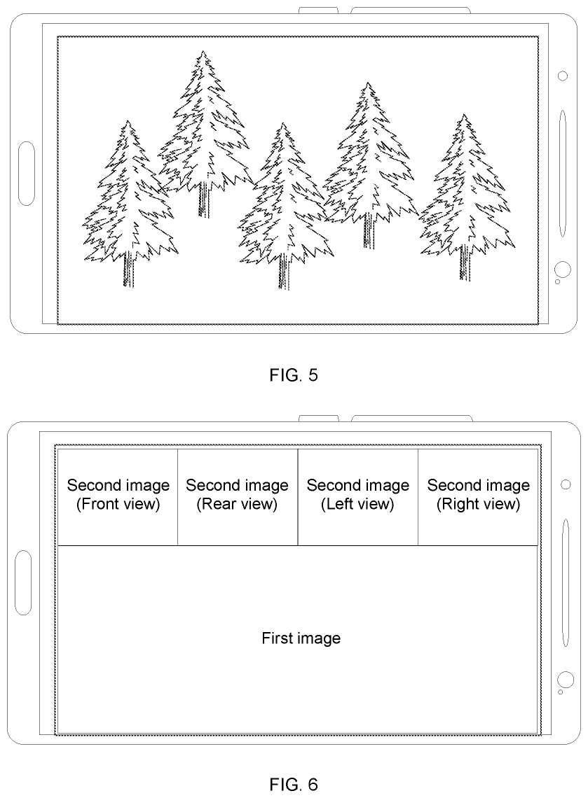

Exemplarily, the first image and the second image are displayed on the same display interface of the terminal device, and the display area of the first image may be larger than the display area of the second image. With reference to FIG. 6, the first image may be displayed in a lower area of the display interface, and the second image captured by the first person view camera or the forward vision camera, as well as the rear vision camera, the left vision camera, or the right vision camera may be displayed in a top area of the display interface. That is, it can provide users with more comprehensive information, and also facilitate users to accurately observe the image of the home point.

Exemplarily, the UAV may detect the information of the photographing device mounted thereon and send the information of the photographing device to the terminal device, so that the terminal device determines the display layout of the first image and/or the second image based on the information of the photographing device. For example, when the UAV is not equipped with a second photographing device, the display interface of the terminal device may only display the first image.

Exemplarily, the terminal device may switch between the first image and/or the second image for display according to the user's operation.

According to the UAV control method provided by some exemplary embodiments of the present application, the first photographing device captures, based on the distance between the UAV and the home point, the first image of the home point and sends the first image to the terminal device for display; it facilitates users to understand the environmental conditions in the area near the home point. The user can operate the terminal device based on the environmental conditions to cause the terminal device to send the first control instruction to the UAV; and the UAV can adjust the UAV's attitude according to the first control instruction, such as avoiding obstacles near the home point, so as to improve the safety of the UAV when it returns to home and land.

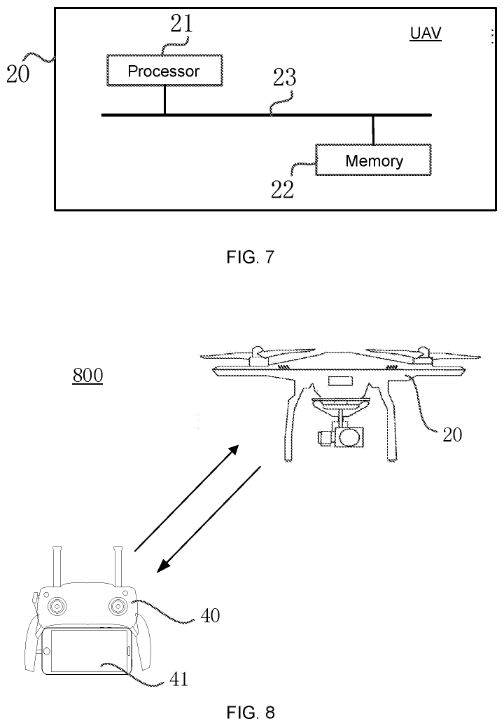

With reference to FIG. 7 and the aforementioned exemplary embodiments, FIG. 7 is a schematic block diagram of a UAV 20 according to some exemplary embodiments of the present disclosure. Optionally, the UAV 20 can be applied to the aforementioned UAV control method.

Exemplarily, the UAV 20 maybe a rotor-type UAV, such as a four-rotor UAV, a six-rotor UAV, an eight-rotor UAV, etc.

Specifically, as shown in FIG. 2, the UAV 20 can communicate with a terminal device. For example, data may be transmitted between the terminal device and the UAV 20 via a wireless channel.

Exemplarily, the terminal device may include at least one of a mobile phone, a tablet computer, a notebook computer, a desktop computer, a personal digital assistant, a wearable device (such as head-mounted glasses), a remote control, etc.

The UAV 20 can carry a first photographing device, which is used to capture images.

Exemplarily, with reference to FIG. 4, the first photographing device 21 maybe directly connected to the UAV 20, and the attitude of the first photographing device 21 can be adjusted by adjusting the attitude of the UAV 20, so as to adjust the photographing direction of the first photographing device 21. For example, the first photographing device 21 mayinclude a vision camera underneath the UAV 20.

Exemplarily, with reference to FIG. 4, the first photographing device 31 is mechanically coupled to the UAV 20 via the gimbal 32. For example, the first photographing device 31 maybe mounted on the gimbal 32, and the gimbal 32 maybe mounted on the UAV 20. The first photographing device 31 maybe fixedly connected to the gimbal 32, or can be detachably connected thereto. The attitude of the first photographing device 31 can be adjusted by adjusting the attitude of the gimbal 32, so as to adjust the photographing direction of the first photographing device 31. For example, the attitude of the gimbal 32 maybe adjusted based on the attitude of the UAV 20 and a target attitude of the first photographing device 31. For example, the gimbal 32 mayinclude a single-axis gimbal, a two-axis gimbal, or a three-axis gimbal; it can adjust the attitude in at least one of the following directions: a pitch direction, a roll direction, or a yaw direction.

The UAV 20 mayinclude one or more processors 21. The one or more processors 21 can work individually or jointly to execute the steps of the aforementioned UAV control method.

Exemplarily, the UAV 20 mayalso include at least one memory (at least one storage medium) 22.

Exemplarily, the processor 21 and the memory 22 are connected via a bus 23; the bus 23 is, for example, an I2C (Inter-integrated Circuit) bus.

Specifically, the processor 21 maybe a micro-controller unit (MCU), a central processing unit (CPU) or a digital signal processor (DSP), etc.

Specifically, the memory 22 maybe a Flash chip, a read-only memory (ROM) disk, an optical disk, a USB disk, a mobile hard disk, or the like.

The processor 21 maybe configured to run a computer program stored in the memory 22 and implement the steps of the aforementioned UAV control method when executing the computer program.

Exemplarily, the processor 21 maybe used to run a computer program stored in the memory 22, and implement the following steps when executing the computer program:
Obtaining a distance between a UAV and a home point;
Obtaining, based on the distance, a first image by photographing the home point with a first photographing device;
Sending the first image to a terminal device for display; and
Upon receiving a first control instruction sent by the terminal device, adjusting, based on the first control instruction, an attitude of the UAV.

The specific principles and implementation methods of the UAV according to the present disclosure are similar to the UAV control method of the abobe exemplary embodiments, and will not be described again herein.

Embodiments of the present disclosure also provide a computer-readable storage medium, where the computer-readable storage medium stores a computer program, and the computer program includes program instructions. When the computer program is executed by the processor, the processor implements the steps of the UAV control method provided by the above exemplary embodiments.

The computer-readable storage medium may be an internal storage unit of the UAV described in any of the preceding exemplary embodiments, such as a hard disk or memory of the UAV. The computer-readable storage medium may also be an external storage device of the UAV. For example, the UAV may be equipped with a plug-in hard disk, a smart media card (SMC), a secure digital (SD) card, a Flash card (Flash Card), etc.

Reference may be made to FIG. 8 in conjunction with the aforementioned exemplary embodiments. FIG. 8 is a schematic block diagram of a UAV system 800 according to some exemplary embodiments of the present disclosure.

The UAV system 800 may include: the aforementioned UAV 20, and the terminal device 40, where the UAV 20 maybe equipped with a photographing device to capture images; the terminal device 40 is connected to the UAV 20 for communication; the display device 41 of the terminal device 40 can display the images captured by the UAV 20.

It should be understood that the terminology used herein is for the purpose of describing particular exemplary embodiments only and is not intended to limit the present disclosure.

It should also be understood that the term “and/or” as used herein refers to and includes any and all possible combinations of one or more of the listed associated items.

The above are only some specific exemplary embodiments of the present disclosure; the scope of protection of the present disclosure is not limited thereto. A person skilled in the art can easily think of various equivalent modifications or substitutions within the technical scope disclosed herein. These modifications or substitutions should be covered by the scope of protection of the present disclosure. Therefore, the scope of protection of the present disclosure should be determined by the scope of protection defined by the appended claims.

What is claimed is:

1. An aircraft, comprising:
a first photographing device;
at least one storage medium storing at least one set of instructions for controlling the aircraft; and
at least one processor in communication with the at least one storage medium, wherein during operation, the at least one processor executes the at least one set of instructions to cause the aircraft to at least:
during a period of the aircraft returning from a first position to landing on a home point, obtain a first image captured by the first photographing device in a direction toward the home point, and
send the first image to a terminal device for display.

2. The aircraft according to claim 1, wherein the at least one processor executes the at least one set of instructions to further cause the aircraft to at least:
during the period of the aircraft returning from the first position to landing on the home point, obtain a second image of a peripheral side of the aircraft captured by a second photography device; and
send the second image to the terminal device for display.

3. The aircraft according to claim 2, wherein the peripheral side includes at least one of a front side, a rear side, a left side, or a right side.

4. The aircraft according to claim 1, wherein at the first position, a distance from the aircraft to the home point is equal to a preset first distance threshold.

5. The aircraft according to claim 1, wherein to obtain the first image captured by the first photographing device in the direction toward the home point, the at least one processor executes the at least one set of instructions to cause the aircraft to at least:
adjust an attitude of the first photographing device to enable a photographing direction of the first photographing device toward the home point; and
obtain the first image captured by the first photographing device.

6. The aircraft according to claim 5, wherein to adjust the attitude of the first photographing device, the at least one processor executes the at least one set of instructions to cause the aircraft to at least:
adjust an angle of the first photographing device in a pitch direction based on an angle between a connection line between the aircraft and the home point and a horizontal plane.

7. The aircraft according to claim 5, wherein to adjust the attitude of the first photographing device, the at least one processor executes the at least one set of instructions to cause the aircraft to at least:
adjust the attitude of the first photographing device based on a vertical height and a horizontal distance between the aircraft and the home point.

8. The aircraft according to claim 7, wherein to adjust the attitude of the first photographing device based on the vertical height and the horizontal distance between the aircraft and the home point, the at least one processor executes the at least one set of instructions to cause the aircraft to at least:
determine a target pitch attitude of the first photographing device based on the vertical height and the horizontal distance between the UAV and the home point; and
adjust the attitude of the first photographing device based on the target pitch attitude.

9. The aircraft according to claim 5, wherein to adjust the attitude of the first photographing device, the at least one processor executes the at least one set of instructions to cause the aircraft to at least:
adjust at least one of an attitude of the aircraft or an attitude of a gimbal carrying the first photographing device.

10. The aircraft according to claim 1, wherein to obtain the first image captured by the first photographing device in the direction toward the home point, the at least one processor executes the at least one set of instructions to cause the aircraft to at least:
obtain the first image captured by a first vision camera mounted below the aircraft.

11. The aircraft according to claim 10, wherein to obtain the first image captured by the first vision camera, the at least one processor executes the at least one set of instructions to cause the aircraft to at least:
obtain the first image captured by a monocular vision camera of a downward-looking binocular vision cameras.

12. The aircraft according to claim 1, wherein to obtain the first image captured by the first photographing device in the direction toward the home point during the period of the aircraft returning from the first position to landing on the home point, the at least one processor executes the at least one set of instructions to cause the aircraft to at least:
obtain the first image directly below the aircraft when the aircraft is directly above the home point.

13. The aircraft according to claim 1, wherein the at least one processor executes the at least one set of instructions to further cause the aircraft to at least:
obtain a second image captured by a second photographing device located on a peripheral side of the aircraft, wherein the peripheral side includes at least one of a front side, a rear side, a left side, or a right side; and
send the second image to the terminal device for display.

14. The aircraft according to claim 2, wherein the second photographing device includes at least one of a first person view camera, a front view camera, a rear view camera, a left view camera, or a right view camera.

15. The aircraft according to claim 1, wherein the at least one processor executes the at least one set of instructions to further cause the aircraft to at least:
upon receiving a first control instruction sent by the terminal device, adjust an attitude of the aircraft based on the first control instruction.

16. The aircraft according to claim 1, wherein the home point is a landing location or a landing area of the aircraft.

17. A control method for an aircraft, comprising:
during a period of the aircraft returning from a first position to landing on a home point, obtaining a first image captured by a first photographing device in a direction toward the home point; and
sending the first image to a terminal device for display.

18. An aircraft system, comprising:
an aircraft; and
a terminal device in communication with the aircraft and having a display device configured to display images, wherein
the aircraft includes:
a first photographing device,
at least one storage medium storing at least one set of instructions for controlling the aircraft, and
at least one processor in communication with the at least one storage medium, wherein during operation, the at least one processor executes the at least one set of instructions to cause the aircraft to at least:
during a period of the aircraft returning from a first position to landing on a home point, obtain a first image captured by the first photographing device in a direction toward the home point, and
send the first image to the terminal device for display.

19. The aircraft system according to claim 18, wherein the at least one processor executes the at least one set of instructions to further cause the aircraft to:
during the period of the aircraft returning from the first position to landing on the home point, obtaining a second image of a peripheral side of the aircraft captured by a second photography device; and
sending the second image to the terminal device for display, wherein
the terminal device is further configured to display the first image and the second image on a same display interface of the display device, and a display area of the first image is larger than a display area of the second image.

20. The aircraft system according to claim 18, wherein the aircraft includes an unmanned aerial vehicle (UAV).
